(19) United States
(12) Patent Application Publication
(10) Pub. No.: US 2008/0268924 A1
(43) Pub. Date: Oct. 30, 2008

(54) RF Shielding System

(76) Inventor: Larry Chung Yao Chang, Walnut, CA (US)

Correspondence Address: CHRISTIE, PARKER & HALE, LLP, PO BOX 7068, PASADENA, CA, 91109-7068, US

(21) Appl. No.: 12/113,029

(22) Filed: Apr. 30, 2008

Related U.S. Application Data
(60) Provisional application No. 60/927,020, filed on Apr. 30, 2007.

(51) Int. Cl. H04M 1/00

(52) U.S. Cl. 455/575.5

(57) ABSTRACT

A cellular phone to be investigated is placed within an RF shielding bag that is formed with conductive materials. A computer transmits investigation commands to a data acquisition device to obtain data stored in the cellular phone. An RF emitter also placed within the RF shielding bag is coupled between the data acquisition device and the cellular phone. At least a portion of a signal line connecting the data acquisition device to the RF emitter is outside the RF shielding bag and may act as an antenna that transmits unwanted RF signals to the cellular phone. The RF emitter corrupts such incoming RF signals not shielded by the RF shielding bag. This helps ensure a forensic sound investigation of the cellular phone.

### CROSS-REFERENCE TO RELATED APPLICATION(S)

This application claims the benefit of U.S. Provisional Application No. 60/927,020, filed Apr. 30, 2007, the content of which is incorporated herein by reference.

### FIELD OF THE INVENTION

The present invention relates generally to RF (radio frequency) shielding systems, and more particularly, to an RF shielding system for forensically-sound harnessing of data stored in electronic devices.

### BACKGROUND OF THE INVENTION

Forensic investigations may often require confiscating cellular phones or other electronic devices to acquire data stored within. In order to acquire such data in a forensically-sound manner, it is desirable to inhibit the cellular phone or like device from receiving signals from external sources (e.g. a cellular base station) as those signals may change or wipe away any stored data. For example, if the cellular phone is capable of receiving signals when the phone is powered-on, data such as the last accessed network may be updated to a current network which may be different than the last accessed network. Furthermore, if the owner of the cellular phone reports the phone as lost, this may cause a base station to transmit a signal to erase all data stored in the phone. Thus, it is desirable to block such signals from reaching the cellular phone or other like device to be investigated.

A prior art mechanism for shielding reception of signals by the cellular phone is to put the phone in an RF shielding bag. FIG. 1 is a schematic block diagram of a data acquisition system that employs a prior art RF shielding bag 10. In this prior art system, a cellular phone 12 is inserted into the RF shielding bag 10 before the phone is powered on. The container 10 is sealed on one end via, for example, velcro strips 18 located generally in the inside of the container. The opposite end of the container includes a small hole 19 for allowing a USB cable 16 to pass through. The cable is used to connect the phone 12 to an acquisition device 14. The acquisition device is configured to acquire data stored in the cell phone during an investigative session.

The prior art RF shielding bag 10 is made of conductive materials and in effect, acts like a Faraday cage. However, the container is not effective in shielding all RF signals. That is, the USB cable 16 that connects the phone 12 to the acquisition device 14 acts as an antenna that transmits RF signals to the cellular phone 12. Thus, prior art cellular data acquisition systems do not ensure that the data acquired from cellular phones are forensically-sound.

Accordingly, what is desired is a more effective RF shielding system for use in cellular phone data acquisition systems and the like, that allows for forensically-sound harnessing of cellular phone data.

### SUMMARY OF THE INVENTION

A data acquisition system includes a data acquisition device operably coupled to an electronic device over a data communications connection. The data acquisition system further includes an electromagnetic energy shielding system containing the electronic device. According to one embodiment, the electromagnetic shielding system includes a container for substantially shielding electronic components within the container from incoming electromagnetic energy. The container may be formed with one or more conductive materials. The electromagnetic shielding system also includes an emitting device coupled between the data acquisition device and the electronic device. The emitting device including circuitry that generates electromagnetic noise corrupting any incoming electromagnetic energy not shielded by the container. The electronic device and the emitting device are substantially contained within the container during a data acquisition process that obtains data stored in the electronic device.

According to one embodiment of the invention, the shielding system further includes one or more first signal lines coupling the data acquisition device to the emitting device, and one or more second signal lines coupling the emitting device to the electronic device. At least a portion of the one or more first signal lines are outside the container during the data acquisition process. The one or more first signal lines transmit the incoming electromagnetic energy not shielded by the container to the emitting device within the container, and the one or more second signal lines transmit the corrupted electromagnetic energy to the electronic device.

According to one embodiment of the invention, the circuitry that generates the electromagnetic noise injects the electromagnetic noise into the one or more second signal lines. The electromagnetic noise may be a radio frequency signal within a predetermined frequency range.

According to one embodiment of the invention, the emitting device includes a low-pass filter for filtering portions of the incoming electromagnetic energy not shielded by the container. According to this embodiment, the electromagnetic noise corrupts the unfiltered portions of the incoming electromagnetic energy.

According to one embodiment of the invention, the container includes a window for viewing an interior of the container. The window includes conductive fabric for substantially shielding entry of incoming RF signals through the window.

According to one embodiment, the present invention is directed to a method for using the shielding system for preventing modification or deletion of the data stored in the electronic device during the data acquisition process.

According to another embodiment, the present invention is directed to a method for acquiring data from an electronic device. A data acquisition device transmits a data acquisition signal directed to the electronic device over a first signal line. The first signal line couples the data acquisition device to a radio frequency (RF) emitter. The RF emitter is in turn coupled to the electronic device over a second signal line. During the data acquisition process, the electronic device, RF emitter, and the second signal line are within an RF shielding container, and the data acquisition device and at least a portion of the first signal line are outside the RF shielding container. The RF shielding container is configured to substantially shield the electronic device from incoming RF signals. Any incoming RF signals transmitted by the first signal line are corrupted with RF noise signals generated by the RF emitter. The data acquisition signal and the corrupted RF signals are output to the electronic device via the second signal line. The data acquisition device receives data stored in the electronic device responsive to the data acquisition signal.

According to one embodiment of the invention, the corrupting includes injecting RF noise signals into the second signal line.

According to one embodiment of the invention, portions of the incoming RF signals not shielded by the container are filtered via a low-pass filter, and the unfiltered portions of the incoming RF signals are corrupted with the RF noise signals.

According to one embodiment of the invention, the corrupted RF signals prevent modification or deletion of the data stored in the electronic device during the data acquisition process.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a schematic block diagram of a data acquisition system that employs a prior art RF shielding bag;

FIG. 2 is a block diagram of a data acquisition system according to one embodiment of the invention;

FIG. 3 is a top perspective view of an RF shielding bag according to one embodiment of the invention;

FIGS. 4A and 4B are respectively an exploded view and an assembled view of a shielded window on an RF shielding bag according to one embodiment of the invention;

FIG. 5 is an exploded view of the RF shielding bag of FIG. 3 according to one embodiment of the invention;

FIG. 6 is a schematic block diagram of an RF emitter according to one embodiment of the invention; and

FIG. 7 is flow diagram of a process for investigating an electronic device via an RF shielding system according to one embodiment of the invention.

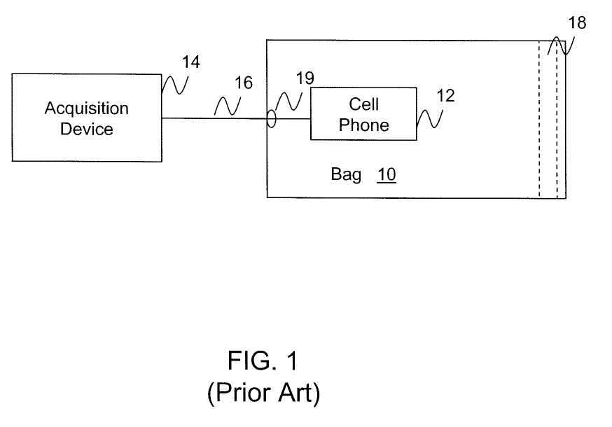

### DETAILED DESCRIPTION

In general terms, the present invention is directed to an electromagnetic shielding system, hereinafter referred to as an RF shielding system, designed to block radio frequency electromagnetic radiation during a data acquisition process. The RF shielding system protects an electronic device, such as a cellular phone, from receiving radio wave, electromagnetic fields, and electrostatic fields, during the data acquisition process for forensically-sound harnessing of data stored within the electronic device. That is, by protecting the electronic device from receiving radio signals that may change or erase data stored in the electronic device, the data that is to be acquired from the electronic device remains forensically sound.

According to one embodiment, a cellular phone to be investigated is placed within an RF shielding bag that is formed with conductive materials. A computer transmits investigation commands to a data acquisition device to obtain data stored in the cellular phone. An RF emitter also placed within the RF shielding bag is coupled between the data acquisition device and the cellular phone. At least a portion of a signal line connecting the data acquisition device to the RF emitter is outside the RF shielding bag and may act as an antenna that transmits unwanted RF signals to the cellular phone. According to one embodiment, the RF emitter corrupts such incoming RF signals not shielded by the RF shielding bag. This helps ensure a forensic sound investigation of the cellular phone.

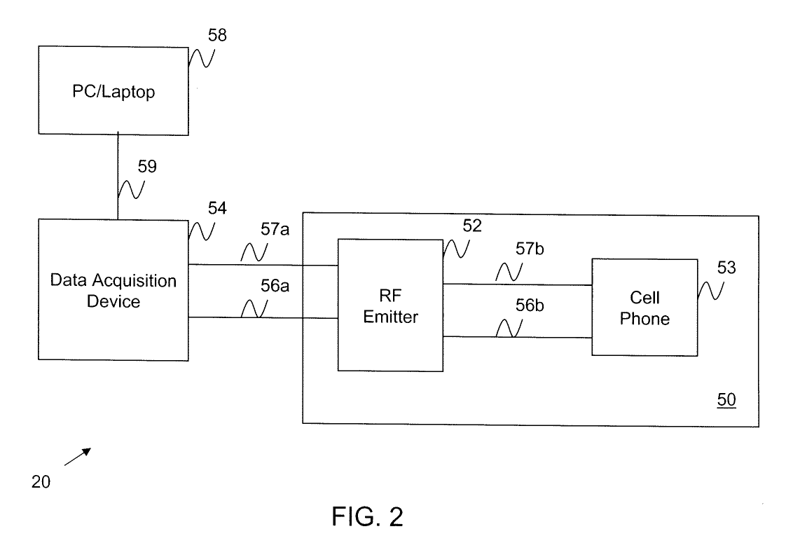

FIG. 2 is a block diagram of a data acquisition system 20 according to one embodiment of the invention. The data acquisition system includes a computer 58 coupled to a data acquisition device 54 over a data communications link 59. The data communications link 59 may be any wired or wireless data communications link conventional in the art, such as, for example, a USB connection, Bluetooth connection, wired or wireless local area network connection, or a wired or wireless wide area network connection such as, for example, the public Internet. The computer 58 uses the data communication link 59 to transmit investigation commands to the data acquisition device 54 for acquiring information stored in an electrical device such as, for example, a cellular phone 53. The data acquisition device 54 in turn uses the data communications link 59 to transmit to the computer 58 information acquired from the cellular phone 53. In this regard, both the computer 58 and data acquisition device 54 are equipped with necessary software and hardware to conduct a data acquisition session and obtain data stored in the cellular phone 53. The data acquisition device 54 may be a data acquisition device sold by Guidance Software, Inc. of Pasadena, Calif., under the name Neutrino™.

The cellular phone 53 may be any wireless radio device capable of communication over a wireless network such as, for example, a cellular network such as a Global System for Mobile communications (GSM) or General Packet Radio Service (GPRS), a wireless local area network such as 802.11a, 802.11b, or 802.11g (collectively referred to as 802.11), or a personal area network such as Bluetooth.

The data acquisition system 20 further includes an RF shielding container/bag 50 in which the cellular phone 53 is placed during a data acquisition session. The RF shielding container 50 is made of sufficient conductive materials to act like a Faraday cage and substantially shield the cellular phone 53 and RF emitter 52 from external RF and electromagnetic (EMC) energy.

The RF shielding container 50 includes an RF emitter 52 coupled in-between the data acquisition device 54 and the cellular phone 53 via data communication lines, such as, for example, USB connections 56a, 56b or proprietary connections 57a or 57b. According to one embodiment of the invention, the RF emitter 52 includes circuitry and logic for physically injecting RF noise signals into the signal lines of outgoing connections 56b, 57b. The noise on the signal lines act to corrupt any RF signals carried by the signal lines that are not filtered by the bag 50. Because at least a portion of the incoming signal lines 56a, 57a to the RF emitter 52 are not contained in the bag, these signal lines may act as antennae that transmit RF signals to the cellular phone. Thus, although most of the external RF signals are filtered by the bag, there is a small amount of RF signals that may still make their way into the bag and the cellular phone 53 via the incoming signal lines 56a, 57a. Such signals may act to modify and/or destroy information stored in the cellular phone. The noise injected by the RF emitter 52, however, corrupts any incoming RF signals so that the cellular phone does not respond to such signals, and hence, does not modify nor destroy information stored in the cellular phone. Thus, the RF emitter 52 in effect acts as a signal jammer for the cellular phone.

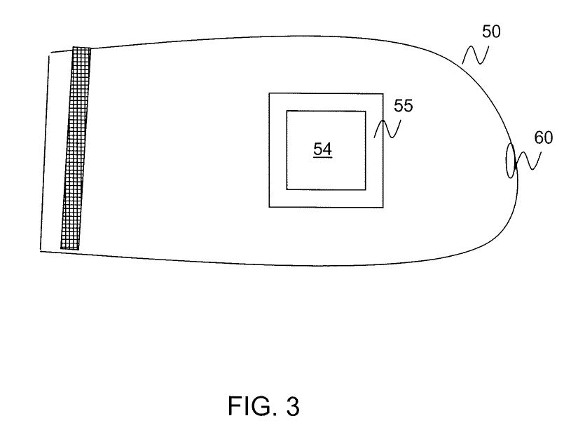

FIG. 3 is a top perspective view of the RF shielding bag 50 according to one embodiment of the invention. A person of skill in the art should recognize, however, that any other RF shielding container conventional in the art may be used in lieu of the RF shielding bag 50.

According to the embodiment illustrated in FIG. 3, the RF shielding bag 50 includes a shielded window 54 on an upward facing portion of the bag for viewing the cellular phone 53 during a data acquisition process. For example, the window may be useful to see if the cellular phone has been powered-on, which mode has been invoked, and the like. The window 54 includes a shielded glass for preventing entry of electromagnetic energy from the window. A metal frame 55 provides additional support for securely affixing the shielded glass onto the bag. The bag also includes one or more holes 60 at one end of the container for receiving the connections 56a, 57a from the data acquisition device 54. The holes are preferably just big enough for the cables to fit through to minimize the amount of electromagnetic energy that may infiltrate into the bag.

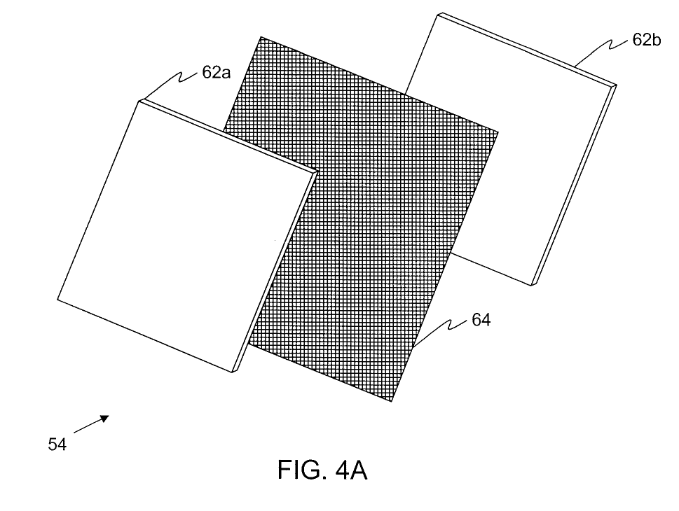

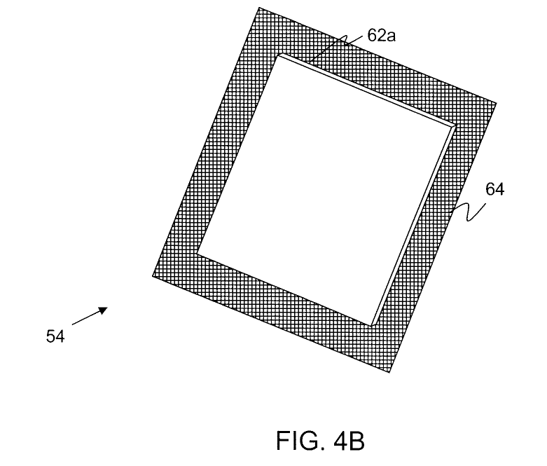

FIG. 4A is an exploded view of the shielded window 54 according to one embodiment of the invention. In the illustrated embodiment, the window is formed with two glasses 62a, 62b and a conductive mesh fabric 64 for being placed in-between the two glasses. The surface area of the mesh 64 is bigger than the surface area of the glass so that, when assembled as is shown in FIG. 4B, there is excess mesh material that spills out from in-between the two glasses, allowing the excess mesh material to be sewn onto the bag. Conductive threads may be used for the sewing. A conductive glue may also be used to further seal any holes that may be created on the bag due to the sewing. The conductive mesh fabric 64 may be composed of fabric and metal such as copper, nickel, copper plus nickel, or any conductive material known in the art.

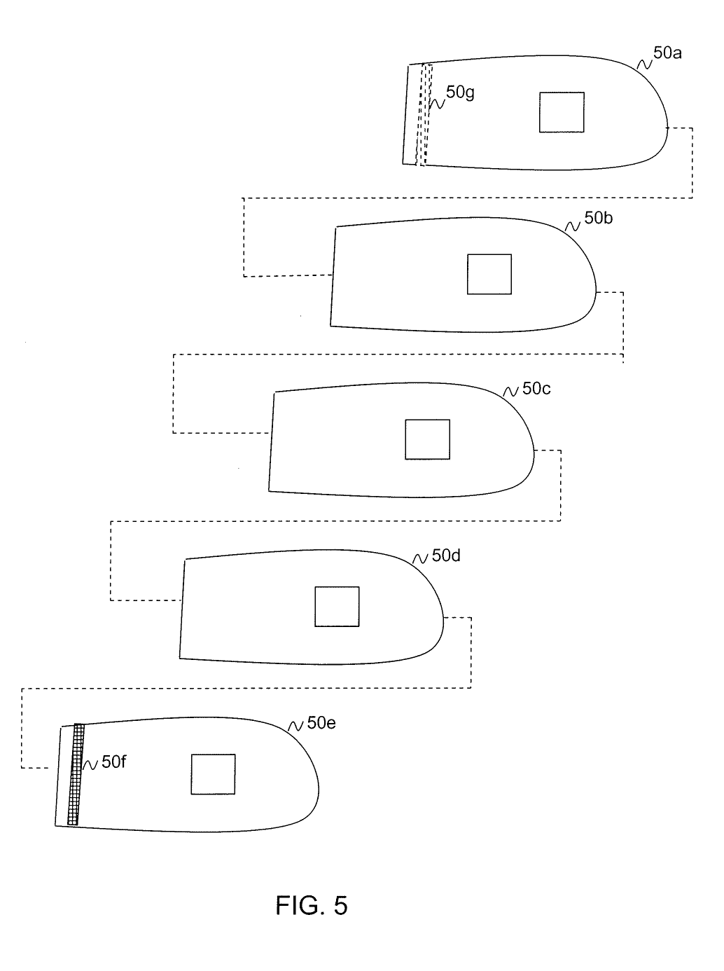

FIG. 5 is an exploded view of the RF shielding bag 50 according to one embodiment of the invention. According to the illustrated embodiment, the bag is composed of five layers of fabric. A top layer 50e is made of regular, non-conductive fabric. A fastener 50f (e.g. velcro) on the front of the top layer mates with a receiving portion of the fastener on the back of the top layer to close the bag. The fastener may be made of either conductive or non-conductive materials.

Three inner layers 50b, 50c, 50d that follow the top layer are made of conductive material composed of fabric and metal such as copper, nickel, copper plus nickel, or the like. The conductive fabric is also referred to as shielded cloth. Although in the illustrated embodiment three layers of shielded cloth are utilized, a person of skill in the art should recognize that more or less than three layers may be used.

The bag further includes an inner lining 50a which is also made of conductive material. The inner lining 50a includes a velcro 50g or other fastener on the inside of the lining for sealing the bag shut. The velcro 50g may be made of either conductive or non-conductive materials.

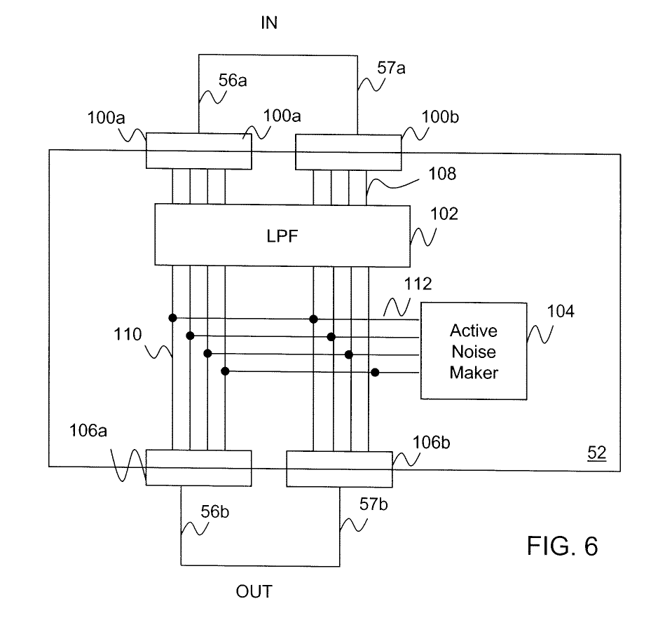

FIG. 6 is a schematic block diagram of the RF emitter 52 according to one embodiment of the invention. The RF emitter includes ports 100a, 100b for receiving the signal lines 56a, 57a from the data acquisition device 54. Although the ports 100a, 100b and a portion of the incoming signal lines are contained in the container during a data acquisition process, the exposed portion of the signal lines act as antennae that conduct RF signals to the cellular phone which may change or damage data stored in the phone.

The RF emitter also includes an optional low-pass filter 102 that filters the high frequency portions of the RF signals that make their way via the incoming signal lines 56a, 57a and lines 108. Any unfiltered portion of the RF signals are transmitted via signal lines 110 to ports 106a, 106b.

According to one embodiment of the invention, the RF emitter 52 includes a noise maker 104 with an oscillator, amplifier, and other circuitry and logic conventional in the art for transmitting RF signal noise in the frequency range of, for example, 850 Mhz/1.9 Ghz, which is the standard cell phone frequency in the United States, and/or 900 Mhz/1.8 Ghz, which is the standard cell phone frequency in other countries. A person of skill in the art should recognize, however, that other frequencies may also be used for the RF signal noise depending on different cell phone frequencies or standard frequencies of other types of electronic devices.

The RF signal noise is transmitted via lines 112 that are physically coupled to the signal lines 110. As a result, RF signal noise is physically injected into lines 110. The injection of the noise causes any RF signal that may be carried via lines 110 to ports 106a, 106b, and output via signal lines 56b, 57b to the cellular phone, to be corrupted. Thus, the cellular phone does not respond to any commands that may be carried via the RF signals infiltrating the bag via the portion of the signal lines 56a, 57a outside of the RF shielding bag 50.

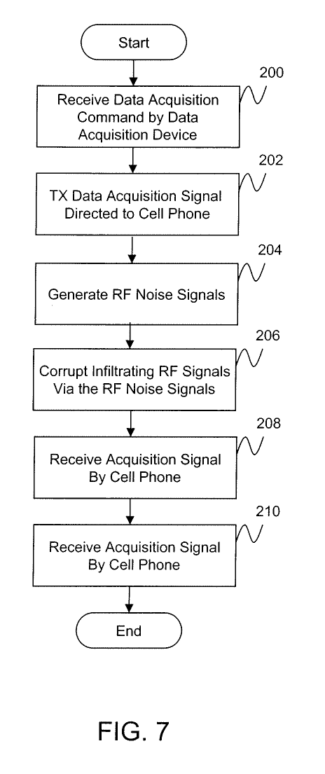

FIG. 7 is flow diagram of a process for investigating an electronic device via the RF shielding system of FIG. 2 according to one embodiment of the invention. At least portions of the process may be via software stored in one or more memory devices as computer program instructions and executed by one or more processors or microcontrollers hosted by the computer 58, data acquisition device 54, or cellular phone 53.

The process starts, and in step 200, the data acquisition device 54 receives a data acquisition command from the computer 58. In step 202, the data acquisition device processes the data acquisition command and transmits a data acquisition signal directed to the cellular phone 53 over the incoming connections 56a, 57a.

The RF emitter 52 receives the data acquisition signal as well as any other RF signals transmitted via the incoming connections 56a, 57a. In step 204, the RF emitter generates RF noise signals via the active noise maker 104.

In step 206, the RF emitter corrupts the RF signals transmitted via the exposed portions of the incoming connections 56a, 57a with the RF noise signals.

In step 208, the cellular phone 53 receives the data acquisition signal forwarded by the RF emitter 52, and in step 210, the cellular phone retrieves and transmits data stored in the phone responsive to the data acquisition signal. Although other RF signals may infiltrate the bag via the incoming connections 56a, 57a, the cellular phone does not respond to those signals as they are corrupted by the RF noise signals. Thus, it should be appreciated that embodiments of the present invention provide an RF shielding system that help prevent modification or deletion of data stored in an electronic device for forensically-sound investigation of the electronic device.

Although this invention has been described in certain specific embodiments, those skilled in the art will have no difficulty devising variations to the described embodiment which in no way depart from the scope and spirit of the present invention. For example, although the above embodiments are described with respect to cellular phones, a person of skill in the art should recognize that the invention is not limited to cellular phones, but may also be employed for other wireless data communication devices including, for example, personal digital assistants (PDAs), personal entertainment devices, laptops, handheld computers, and other consumer electronic devices conventional in the art. Furthermore, to those skilled in the various arts, the invention itself herein will suggest solutions to other tasks and adaptations for other applications. It is the Applicants' intention to cover all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive.

What is claimed is:

1. In a data acquisition system including a data acquisition device operably coupled to an electronic device over a data communications connection, an electromagnetic energy shielding system containing the electronic device, the electromagnetic shielding system comprising:
a container for substantially shielding electronic components within the container from incoming electromagnetic energy; and
an emitting device coupled between the data acquisition device and the electronic device, the emitting device including circuitry that generates electromagnetic noise corrupting any incoming electromagnetic energy not shielded by the container, wherein the electronic device and the emitting device are substantially contained within the container during a data acquisition process that obtains data stored in the electronic device.

2. The shielding system of claim 1 further comprising:
one or more first signal lines coupling the data acquisition device to the emitting device; and
one or more second signal lines coupling the emitting device to the electronic device.

3. The shielding system of claim 2, wherein at least a portion of the one or more first signal lines are outside the container during the data acquisition process.

4. The shielding system of claim 2, wherein the one or more first signal lines transmit the incoming electromagnetic energy not shielded by the container to the emitting device within the container, and the one or more second signal lines transmit the corrupted electromagnetic energy to the electronic device.

5. The shielding system of claim 4, wherein the circuitry that generates the electromagnetic noise injects the electromagnetic noise into the one or more second signal lines.

6. The shielding system of claim 1, wherein the electromagnetic noise is a radio frequency signal within a predetermined frequency range.

7. The shielding system of claim 1, wherein the emitting device includes a low-pass filter for filtering portions of the incoming electromagnetic energy not shielded by the container, and wherein the electromagnetic noise corrupts the unfiltered portions of the incoming electromagnetic energy.

8. The shielding system of claim 1, wherein the container includes a window for viewing an interior of the container.

9. The shielding system of claim 1, wherein the window includes conductive fabric for substantially shielding entry of incoming RF signals through the window.

10. The shielding system of claim 1, wherein the container is formed with one or more conductive materials.

11. A method for using the shielding system of claim 1 for preventing modification or deletion of the data stored in the electronic device during the data acquisition process.

12. A method for acquiring data from an electronic device, the method comprising:
transmitting by a data acquisition device a data acquisition signal directed to the electronic device over a first signal line, the first signal line coupling the data acquisition device to a radio frequency (RF) emitter, the RF emitter being in turn coupled to the electronic device over a second signal line, wherein during the data acquisition process, the electronic device, RF emitter, and the second signal line are within an RF shielding container, and the data acquisition device and at least a portion of the first signal line are outside the RF shielding container, the RF shielding container being configured to substantially shield the electronic device from incoming RF signals;
generating by the RF emitter RF noise signals;
corrupting the incoming RF signals transmitted by the first signal line with the RF noise signals;
outputting the data acquisition signal and the corrupted RF signals to the electronic device via the second signal line; and
receiving by the data acquisition device data stored in the electronic device responsive to the data acquisition signal.

13. The method of claim 12, wherein the corrupting includes injecting RF noise signals into the second signal line.

14. The method of claim 12, wherein the RF noise signals are RF signals within a predetermined frequency range.

15. The method of claim 12 further comprising:
filtering portions of the incoming RF signals not shielded by the container via a low-pass filter; and
corrupting the unfiltered portions of the incoming RF signals with the RF noise signals.

16. The method of claim 12, wherein the corrupted RF signals prevent modification or deletion of the data stored in the electronic device during the data acquisition process.

17. The method of claim 12, wherein the RF shielding container is formed with one or more conductive materials.
